(19) United States
(12) Patent Application Publication
(10) Pub. No.: US 2003/0104739 A1
(43) Pub. Date: Jun. 5, 2003

(54) Protective material

(76) Inventors: Steven J. Jenkins, Solihull (GB); Jianrong Ren, Geneva (CH)

Correspondence Address: KONNEKER SMITH, 660 NORTH CENTRAL EXPRESSWAY, SUITE 230, PLANO, TX, 75074

(21) Appl. No.: 10/150,667

(22) PCT Filed: Nov. 23, 2000
(86) PCT No.: PCT/GB00/04473

(30) Foreign Application Priority Data
Nov. 23, 1999 (GB) 9927674.3

(51) Int. Cl. B32B 3/00; B32B 5/02; B32B 27/04

(52) U.S. Cl. 442/135; 442/59; 442/239; 442/246; 442/248; 442/252; 442/253; 442/381; 442/134

(57) ABSTRACT

A protective material comprises in one embodiment a plurality of separate flexible layers, each layer including a plurality of high-strength fibers capable of resisting penetration by a knife or sharp-pointed objects, such as ice picks and hypodermic needles, and a support material, wherein at least part of the fibers are embedded within the support material to restrict relative movement of the fibers therein. The high-strength fibers have a denier of less than or equal to 600.

This invention relates to a protective material.

It is known to use personal body armour to give protection against a wide variety of threats. This armour typically comprises a pack containing layers of woven aramid fibre, such as the poly(p-phenylene terephthalamide) yarn sold by E. I. du Pont de Nemours and Company under the trademark, KEVLAR®, or woven or non woven forms of materials made of other high-strength fibres such as Ultra-High-Molecular-Weight Polyethylene, marketed under the trademarks of Spectra® and Dyneema®; and more recently of poly (p-phenylene-2,6-benzobisoxazole) marketed under the trademark of Zylon® by Toyobo of Japan.

It is also known to provide additional material to reduce the trauma effect caused to the wearer by the impact of the projectiles. The additional material may comprise, for example, one or more layers of plastic or rubber foam; one or more polyolefin sheets; or layers of felts.

It is well known that flexible armours for ballistic threats of the description above are not necessarily effective against stabbing by knives or sharp pointed instruments. Protection against knives and sharp-pointed instruments is required, traditionally, a stab-resistant component is added to the flexible protection armour, which comprises, for example, metal meshes; lightweight metal panels; overlapping medallions of lightweight metal; or laminated or coated fabrics of a high-strength fibre such as KEVLAR® or poly (p-phenylene-2,6-benzobisoxazole) marketed under the trademark of Zylon® by Toyobo of Japan.

It will be appreciated that the stab-protection component in the flexible protection armour comprising of any metallic component would inevitably add to the thickness and weight of the garment, therefore reducing its comfort and wearability.

Stab-protection materials comprising of coated or laminated a woven fabric of aramid fibres are either disclosed or commercially available. Examples are:

KEVLAR® Comfort AS Style 288, which comprises a fabric of woven KEVLAR® of 840 denier at a density of 10.7×10.7 ends/cm, and laminated with an ionomeric polymer;

Protective material disclosed in UK Patent Application 2,304,350 A. An example of which is a fabric of woven aramid yarn of 840 denier at a density of 11×11 ends/cm and coated with a resin comprising of bisphenol A and bisphenol F.

Currently, coated or laminated fabrics based on high strength fibres for stab or puncture protection purposes either commercially available or disclosed in the prior art are almost exclusively based on a fabric woven with fibres of greater than 840 denier. While these materials represent a major improvement on the comfort and wearability as compared to metallic materials, the finished armours are still relatively rigid, bulky and heavy.

It has been discovered that in a coated or laminated fabric as described above, stab-resistance against knives and sharp pointed objects is dramatically increased if the woven fabric is based on high-strength fibres of lower deniers, which is defined as fibres of less than 600 denier. It has also been discovered that the finished armour containing coated or laminated woven fabrics of lower denier fibres exhibited a surprisingly high flexibility and low thickness.

In one aspect, the present invention provides a protective material comprising at least one layer of layer comprising a plurality of fibres capable of resisting penetration by a bullet or a knife, and a support material, wherein at least part of said fibres are embedded within the support material to restrict relative movement of the fibres therein, and wherein the fibres have a denier below 840, preferably below 600.

In another aspect, the present invention provides a protective material comprising at least one layer of comprising a plurality of fibres capable of resisting penetration by a bullet or a knife, and a support layer laminated with the or each fibrous layer wherein the fibres of the fibrous have a denier below 840. Preferably below 600. In this aspect of the invention, the fibrous layer need not necessarily be embedded in the support layer.

The fibres are preferably high strength fibres, i.e., the type of fibres discussed above which are suitable for use in personal body armour for reducing the impact effects of bullets, knives, etc. Typically, the breaking strength of the fibres is 10 g/denier or above.

In both the above aspects of the invention, the layers are advantageously flexible. The layers may be sufficiently flexible that they are not capable of supporting their own weight.

We have obtained especially good results when the denier of the fibres is less than or equal to about 600. Even better results have been achieved when the denier of the fibres is less than or equal to about 400. In an embodiment, the denier is less than 400. The minimum practical value of the denier is about 30-40, but we prefer that the denier is 100 or more, preferably 150 or more. We have obtained vary good results in the denier range from 200 to less than 400.

Preferably there are at least two layers. In general, we prefer to provide from 5 to 50 layers, more preferably 10 to 50 layers. However, we have found that 10 to 30 layers are usually sufficient.

The support material is preferably coated or laminated with a resin solution or resin film. The resin may be a thermoplastic resin such as ionic polyethylene (Surlyn, low density polyethylene, a phenolic resin (e.g. a mixture of phenolic poly(vinyl butral), an epoxy resin or mixtures thereof. The resin preferably comprises 10 to 60% of the total weight of the fibres and resin.

This invention involves the use of fabrics of high-strength fibres such as KEVLAR® and Zylon, particularly Keviar fabrics, woven with low denier fibres. Examples of such fabric are currently commercial or semi commercial with the following types;

| Denier | Ends/inch | Dry weight (g/m2) |
|---|---|---|
| 200 | 36.5 × 36.5 | 60 |
| 400 | 31 × 31 | 105 |
| 400 | 36.5 × 36.5 | 120 |
| 600 | 31 × 31 | 160 |
| 600 | 29 × 29 | 158 |

The present invention provides a fabric that can be used in protective garments including, knife protection vests, bulletproof vests and multiple threat vests. The material is preferably included as a multiple-sheet pack. The material can be used in conjunction with other protective materials, such as unresinated soft Kevlar (RTM) fabric to form a multiple-threat vest. The protective material can be sown into the rest of the garment, or it can be provided in a pack which is sown into the garment. Alternatively, the protective material (or a pack containing it), may simply be placed inside an suitable sized pocket provided in the garment.

The protective material according to the invention provides (preferably in conjunction with Kevlar ballistic soft fabrics and Kevlar Correctional) an excellent lightweight and flexible multi-threat vest against knives, ice-picks, hypodermic needles and bullets with, preferably.

The following examples further illustrate the invention.

Test Method:

Penetration-resistance is tested according to two standards from the United Kingdom Home office, Police Science and Development Branch (PSDB)

Examples 1-10 are tested according to a modified method to Standard for Stab Resistant Body Armour, Test procedure (1993).

The test blades are PSDB No.1 and No.5 blades (1993). The blades are fixed firmly on a knife missile which weighs 2.2 kg. The knives are launched in a free drop tube, modelling that in Mellrichstadt Laboratory, Germany. The attacking energy is adjusted by adjusting the drop height according to the equation:

Energy(j)=Mass(Kg knife+missile)×Height(m)×g(9.8)

The backing material is Roma Plastilina® No.1 as conditioned according to National Institute of Justice, Ballistic Resistance of Police Body Armor, NIJ Standard 0101.03.

### EXAMPLES 1-5

Table 1 shows five test armour packs for duel knife and bullet protection with an identical construction as following:

Striking face: 23 layers of soft bullet-resistant fabric made of a woven KEVLAR® fabric with a fibre of 840 denier and a weave construction of 10.2×10.2 ends/cm. 23 layers are required to defeat Hand-Gun Protection Level I (HG1) in PSDB Ballistic Body Armour Standard (1995).

Back face: a multi-layer pack of stab-resistant material comprising woven KEVLAR® fabrics woven with fibres of different denier coated with an epoxy resin at 50±10% by weight.

Further it shows that in order to have less than 7 mm of penetration through the pack at an attacking energy of 24 Joules with the No.1 Knife, the amount of the stab-resistant material required as expressed in areal density (kg/m2).

TABLE 1
Armour Areal Density for Penetration
less than 7 mm At 24 Joules of Attacking Energy

| | | | Base fabric | | |
|---|---|---|---|---|---|
| | | | weight for | | |
| | Striking | Stab pack | coated | Stab Pack | |
| Test | Face, | Denier of | fabric | Areal density | Total Areal |
| Sample | (kg/m2) | the fabric | (g/m2) | (kg/m2) | Density |
| 1 | 4.26 | 200 | 65 | 2.0 | 6.26 |
| 2 | 4.26 | 400 | 105 | 2.24 | 6.50 |
| 3 | 4.26 | 840 | 170 | 3.08 | 7.34 |
| 4 | 4.26 | 1500 | 220 | 3.53 | 7.79 |
| 5 | 4.26 | 3000 | 460 | 4.70 | 8.96 |

The above results shows that the armour areal density required for penetration less than 7 mm with 24 joules of attacking energy reduces significantly when the denier of the fibre used in the coated woven fabric for stab protection is below 840 denier, thus resulting lighter and thinner armours. Also the reduction in areal density required is significant as a result of using low denier fibres (13-43% reduction).

### EXAMPLES 6-10

Table 2 shows five test armour packs for duel knife and bullet protection with an identical construction as following:

Striking face: 23 layers of soft bullet-resistant fabric made of a woven KEVLAR® fabric with a fibre of 840 denier with a weave construction of 10.2×10.2 ends/cm. 23 layers are required to defeat Hand-Gun Protection Level I (HG1) in “PSDB Ballistic Body Armour Standard (1995)”.

Back face: a multi-layer pack of stab-resistant material comprising woven KEVLAR® fabrics woven with fibres of different denier coated with an epoxy resin at 50±10% by weight.

Further it shows that in order to have less than 7 mm of penetration through the pack at an attacking energy of 36 Joules with the No.1 Knife, the amount of the stab-resistant material required as expressed in areal density (kg/m2).

TABLE 2
Armour Areal Density for Penetration
less than 7 mm At 36 Joules of Attacking Energy

| | | | Base fabric | | |
|---|---|---|---|---|---|
| | | | weight for | | |
| | Striking | Stab pack | coated | Stab Pack | |
| Test | Face, | Denier of | fabric | Areal density | Total Areal |
| Sample | (kg/m2) | the fabric | (g/m2) | (kg/m2) | Density |
| 1 | 4.26 | 200 | 65 | 2.29 | 6.54 |
| 2 | 4.26 | 400 | 105 | 2.74 | 7.00 |
| 3 | 4.26 | 840 | 170 | 3.86 | 8.12 |
| 4 | 4.26 | 1500 | 220 | 4.89 | 9.14 |
| 5 | 4.26 | 3000 | 460 | 7.74 | 10.00 |

The above results shows that the armour areal density required for penetration less than 7 mm with 36 joules of attacking energy reduces significantly when the denier of the fibre used in the coated woven fabric for stab protection goes below 840 denier, thus resulting lighter and thinner armours. Also the reduction in areal density required is even more significant than in Table 3 (16-53%).

### EXAMPLE 11-12

Examples 11-12 are tested according to PSDB Stab Resistance Standard For Body Armour (1999).

Two test blades designed to replicate a class of actual knives used assaults on police are specified: the first replicates a typical small knife (PSDB designation S1) and a second which replicates the performance of larger commando style blades (P1).

When conducting testing, the blades as described above are fixed to a missile which drops freely under its own weight to strike the test armour at a specified energy and velocity. The knife missile comprises two defined masses connected by a damping arrangement in order to accurately reflect the energy delivery of a human hand stabbing action.

A composite material consisting, from the striking face, of four layers of 6 mm RA110 neoprene, followed by a single layer of 33 kg/m³ Plastazote® foam, backed by 2 layers of 6 mm 2494D rubber.

The test results are reported as penetration (mm) measured by the length of the blade protruding from the rear surface of the test sample. An armour model submitted for testing should be designed to meet one of the three protection levels, each with two attacking energy levels and allowed depths of penetration:

| | | Maximum | | Maximum |
|---|---|---|---|---|
| | Energy E1 | Penetration | Energy E2 | Penetration |
| | (Joule) | (mm) | (Joule) | (mm) |
| KR1 | 24 | 7 | 36 | 20 |
| KR2 | 33 | 7 | 50 | 20 |
| KR3 | 43 | 7 | 65 | 20 |

### EXAMPLE 11

### Test Armour

A combined stab and bullet protection armour pack is constructed of thirty-eight (38) layers of a special laminate of the following construction:

Two layers of KEVLAR® Fabric Style 431 G hot-laminated with one layer of ionomeric polymer of 40 g/m2. Kevlar® Fabric Style 431 G is woven with 400 denier KEVLAR® yarn with a weave construction of 31×31, giving an areal density of 105 g/m2. The final laminate weight is 250 g/m2.

### EXAMPLE 12

### Reference Armour

A combined stab and bullet protection pack is constructed with thirty-eight (38) layers of KEVLAR® Comfort AS 288 which is of the following composition:

A KEVLAR® fabric woven with 840 denier KEVLAR® K-129 fibre with a weave construction of 10.7×10.7 ends/cm, resulting a fabric weight of 210 g/m2. The fabric is then laminated with the same ionomeric polymer of 40 g/m2 as in Example 11. The final laminate weight is 250 g/m2;

TABLE 3
Test Result Comparison
of Examples 11 and 12 at Knife Protection Level I

| | | | | Knife-Resistance |
|---|---|---|---|---|
| | Attacking | | | Level (PSDB |
| Armour Pack | Energy (J) | Strike No. | penetration | 1999) |
| Example 12 | 24.9 | 1 | 0 | Pass |
| (Reference) | 25.0 | 2 | 1 | Pass |
| | 37.1 | 3 | 13 | Pass |
| | 36.7 | 4 | 10 | Pass |
| Example 11 | 24.6 | 1 | 0 | Pass |
| (Test | 24.2 | 2 | 0 | Pass |
| Sample) | 36.9 | 3 | 0 | Pass |
| | 36.3 | 4 | 0 | Pass |

TABLE 4
Test Result Comparison
of Examples 11 and 12 at Knife Protection Level II

| | | | | Knife-Resistance |
|---|---|---|---|---|
| | Attacking | | | Level (PSDB |
| Armour Pack | Energy (J) | Strike No. | penetration | 1999) |
| Example 12 | 33.9 | 1 | 6 | Pass |
| (Reference) | 33.7 | 2 | 10 | Pass |
| | 50.4 | 3 | Complete pen. | Fail |
| Example 11 | 33.2 | 1 | 0 | Pass |
| (Test | 33.5 | 2 | 0 | Pass |
| Sample) | 50.4 | 3 | 11 | Pass |
| | 50.1 | 4 | 10 | Pass |

Tables 3 and 4 conclusively demonstrates that stab protection materials comprising laminated woven KEVLAR® fabrics show significantly different stab resistance depending on the denier of KEVLAR® fibre in the woven fabric. A laminated woven KEVLAR® fabric comprising fibre deniers below 840 denier give surprising higher stab-resistance than those above 840 denier.

This invention is applicable to the protective material described in UK patent number 2304350, a copy of the specification of which is set out below, and which forms a part of the specification for the present application. This patent specification was published on Jun. 30, 1999.

In particular the present invention can be applied to all the matter of GB-B-2304350, subject to the denier of the fibres being below 840, more preferably equal to or below 600, and most preferably equal to or below 400. It should also be noted that when applying the present invention to the disclosure of GB-B-2304350, it is not necessarily essential to provide more than one flexible layer, although this is preferred. Also, it is not essential in the present invention that the layers are separate, but, again, this feature is preferred.

It will be appreciated that the invention may be modified.

What is claimed is:

1. A protective material, comprising:
a plurality of separate flexible layers, each layer including a plurality of high-strength fibers which resist penetration by a sharp object; and
a support material,
wherein at least a portion of the fibers are embedded within the support material, thereby restricting relative movement of the fibers therein, and
wherein the fibers have a denier of less than or equal to approximately 600.

2. The protective material according to claim 1, wherein the support material is a resin.

3. The protective material according to claim 2, wherein the resin is a synthetic resin.

4. The protective material according to claim 2, wherein the resin is a selected one of epoxy-based resin, phenolic-based resin, and polyester-based resin.

5. The protective material according to claim 1, wherein the support material is a thermosetting resin.

6. The protective material according to claim 1, wherein the fibers include at least one of ultra-high-molecular-weight polyethylene fibers, glass fibers, carbon fibers, ballistic Nylon fibers, poly (p-phenylene-2,6-benzobisoxazole) fibers, and aramid fibers.

7. The protective material according to claim 1, wherein the fibers include poly (p-phenylene terephthalamide) fibers.

8. The protective material according to claim 1, wherein the support material is approximately 10 to 60% by weight of the protective material.

9. The protective material according to claim 1, wherein there are approximately 5 to 50 of the flexible layers.

10. The protective material according to claim 1, wherein each of the flexible layers has a thickness of approximately 0.1 to 0.6 mm.

11. The protective material according to claim 1, wherein the denier of the fibers is approximately 200 to 600.

12. The protective material according to claim 1, wherein the denier of the fibers is less than 400 and greater than approximately 200.

13. The protective material according to claim 1, further comprising a non-resinated soft fabric which resists ballistic penetration.

14. The protective material according to claim 13, wherein the fabric is woven.

15. The protective material according to claim 13, wherein the fabric is non-woven.

16. The protective material according to claim 1, wherein the support material has a rigidity which permits each flexible layer to support its own weight.

17. A protective material, comprising:
a plurality of separate flexible layers, each layer including a plurality of high-strength fibers which resist penetration by a sharp object; and
at least one support layer laminated with the flexible layers, the support layer including a support material, and
wherein the fibers have a denier of less than or equal to approximately 600.

18. The protective material according to claim 17, wherein the support material is a resin.

19. The protective material according to claim 18, wherein the resin is a synthetic resin.

20. The protective material according to claim 18, wherein the resin is a selected one of epoxy-based resin, phenolic-based resin, and polyester-based resin.

21. The protective material according to claim 17, wherein the support material is a thermosetting resin.

22. The protective material according to claim 17, wherein the fibers include at least one of ultra-high-molecular-weight polyethylene fibers, glass fibers, carbon fibers, ballistic Nylon fibers, poly (p-phenylene-2,6-benzobisoxazole) fibers, and aramid fibers.

23. The protective material according to claim 17, wherein the fibers include poly (p-phenylene terephthalamide) fibers.

24. The protective material according to claim 17, wherein the support material is approximately 10 to 60% by weight of the protective material.

25. The protective material according to claim 17, wherein there are approximately 5 to 50 of the flexible layers.

26. The protective material according to claim 17, wherein each of the flexible layers has a thickness of approximately 0.1 to 0.6 mm.

27. The protective material according to claim 17, wherein the denier of the fibers is approximately 200 to 600.

28. The protective material according to claim 17, wherein the denier of the fibers is less than 400 and greater than approximately 200.

29. The protective material according to claim 17, further comprising a non-resinated soft fabric which resists ballistic penetration.

30. The protective material according to claim 29, wherein the fabric is woven.

31. The protective material according to claim 29, wherein the fabric is non-woven.

32. The protective material according to claim 17, wherein the support material has a rigidity which permits each flexible layer to support its own weight.

33. A protective garment, comprising:
a protective material including a support material, and a plurality of separate flexible layers, each layer including a plurality of high-strength fibers which resist penetration by a sharp object,
wherein at least a portion of the fibers are embedded within the support material, thereby restricting relative movement of the fibers therein, and
wherein the fibers have a denier of less than or equal to approximately 600.

34. The protective garment according to claim 33, wherein the support material is a resin.

35. The protective garment according to claim 34, wherein the resin is a synthetic resin.

36. The protective garment according to claim 34, wherein the resin is a selected one of epoxy-based resin, phenolic-based resin, and polyester-based resin.

37. The protective garment according to claim 33, wherein the support material is a thermosetting resin.

38. The protective garment according to claim 33, wherein the fibers include at least one of ultra-high-molecular-weight polyethylene fibers, glass fibers, carbon fibers, ballistic Nylon fibers, poly (p-phenylene-2,6-benzobisoxazole) fibers, and aramid fibers.

39. The protective garment according to claim 33, wherein the fibers include poly (p-phenylene terephthalamide) fibers.

40. The protective garment according to claim 33, wherein the support material is approximately 10 to 60% by weight of the protective material.

41. The protective garment according to claim 33, wherein there are approximately 5 to 50 of the flexible layers.

42. The protective garment according to claim 33, wherein each of the flexible layers has a thickness of approximately 0.1 to 0.6 mm.

43. The protective garment according to claim 33, wherein the denier of the fibers is approximately 200 to 600.

44. The protective garment according to claim 33, wherein the denier of the fibers is less than 400 and greater than approximately 200.

45. The protective garment according to claim 33, further comprising a non-resinated soft fabric which resists ballistic penetration.

46. The protective garment according to claim 45, wherein the fabric is woven.

47. The protective garment according to claim 45, wherein the fabric is non-woven.

48. The protective garment according to claim 33, wherein the support material has a rigidity which permits each flexible layer to support its own weight.

49. The protective garment according to claim 33, wherein the garment is a vest.

50. The protective garment according to claim 33, wherein the garment is a jacket.

51. The protective garment according to claim 33, wherein the garment is an item of headwear.

52. The protective garment according to claim 33, wherein the garment is an item of footwear.

53. The protective garment according to claim 33, wherein the protective material is provided in the form of a pack which is releasably secured to a portion of the garment.

54. A protective garment, comprising:
a protective material including a plurality of separate flexible layers, each layer including a plurality of high-strength fibers which resist penetration by a sharp object, and at least one support layer laminated with the flexible layers, the support layer including a support material, and
wherein the fibers have a denier of less than or equal to approximately 600.

55. The protective garment according to claim 54, wherein the support material is a resin.

56. The protective garment according to claim 55, wherein the resin is a synthetic resin.

57. The protective garment according to claim 55, wherein the resin is a selected one of epoxy-based resin, phenolic-based resin, and polyester-based resin.

58. The protective garment according to claim 54, wherein the support material is a thermosetting resin.

59. The protective garment according to claim 54, wherein the fibers include at least one of ultra-high-molecular-weight polyethylene fibers, glass fibers, carbon fibers, ballistic Nylon fibers, poly (p-phenylene-2,6-benzobisoxazole) fibers, and aramid fibers.

60. The protective garment according to claim 54, wherein the fibers include poly (p-phenylene terephthalamide) fibers.

61. The protective garment according to claim 54, wherein the support material is approximately 10 to 60% by weight of the protective material.

62. The protective garment according to claim 54, wherein there are approximately 5 to 50 of the flexible layers.

63. The protective garment according to claim 54, wherein each of the flexible layers has a thickness of approximately 0.1 to 0.6 mm.

64. The protective garment according to claim 54, wherein the denier of the fibers is approximately 200 to 600.

65. The protective garment according to claim 54, wherein the denier of the fibers is less than 400 and greater than approximately 200.

66. The protective garment according to claim 54, further comprising a non-resinated soft fabric which resists ballistic penetration.

67. The protective garment according to claim 66, wherein the fabric is woven.

68. The protective garment according to claim 45, wherein the fabric is non-woven.

69. The protective garment according to claim 54, wherein the support material has a rigidity which permits each flexible layer to support its own weight.

70. The protective garment according to claim 54, wherein the garment is a vest.

71. The protective garment according to claim 54, wherein the garment is a jacket.

72. The protective garment according to claim 54, wherein the garment is an item of headwear.

73. The protective garment according to claim 54, wherein the garment is an item of footwear.

74. The protective garment according to claim 54, wherein the protective material is provided in the form of a pack which is releasably secured to a portion of the garment.
